(19) United States
(12) Patent Application Publication
(10) Pub. No.: US 2026/0233485 A1
(43) Pub. Date: Aug. 13, 2026

(54) SYSTEM AND A METHOD FOR MANUFACTURING SCREW CAPS FROM CARDBOARD OR PAPERBOARD

(71) Applicant: Länsipahvi Oy, Masku (FI)

(72) Inventor: Matti SALONOJA, Masku (FI)

(21) Appl. No.: 19/532,103

(22) Filed: Feb. 6, 2026

(30) Foreign Application Priority Data
Feb. 13, 2025 (EP) 25157696.3

(51) Int. Cl. B31B 50/81; B31B 50/20; B31B 50/59; B31B 120/10

(52) U.S. Cl. CPC B31B 50/81; B31B 50/20; B31B 50/59; B31B 2120/10

(57) ABSTRACT

A system for manufacturing screw caps from cardboard or paperboard comprises cutting tools configured to cut pieces of the cardboard or paperboard, folding tools configured to fold each piece to form a cap blank (110) such that a sidewall (116) of the cap blank has two-fold cardboard or paperboard, and shaping tools comprising support elements (111-113) and a roller (114) rotatably supported with respect to the support elements. The support elements are configured to press a contact surface of the roller against a surface of the sidewall of the cap blank and simultaneously scroll the roller along the surface of the sidewall. The contact surface of the roller has a helical pattern for forming by pressing at least one thread section (118) on the surface of the sidewall of the cap blank when the roller is scrolled along the surface of the sidewall.

### TECHNICAL FIELD

The invention relates generally to manufacturing utility articles from cardboard or paperboard. More particularly, the invention relates to a system and to a method for manufacturing screw caps from cardboard or paperboard. Furthermore, the invention relates to a screw cap made of cardboard or paperboard.

### BACKGROUND

Packages made of laminated paper- or cardboard for liquid or semi-liquid food stuff such as milk, water, juice, custard, yoghurt, etc. have been known for decades. A significant benefit of these paper- or cardboard packages is that the packages are biodegradable to much more extent than corresponding plastic packages. Instead, screw caps for packages of the kind mentioned above are typically manufactured from plastics.

Nowadays, there is a great endeavor to reduce amount of plastics as well as other non-renewable materials in utility articles such as the above-mentioned screw caps. Publication EP3080003 describes method for manufacturing a screw cap having a blind hole with inner threads using microfibrillated cellulose “MFC” that is cellulose where an outer layer of the fibers has been stripped away by mechanical shearing, exposing the fibril bundles. These fibrils are much smaller in diameter compared to the original fibers. The method comprises placing a piece of pre-preg MFC of a suitable size for forming the screw cap between a first tool comprising a protruded part with outer threads for forming inner threads of the blind hole and a second tool comprising a section with an inner lateral surface for forming an outer lateral surface of the screw cap, moving the protruded part of the first tool into the section of the second tool so that the first and the second tool form the screw cap, drying the piece of the pre-preg MCF, such that it is shrinks onto the first tool and thereby forms the screw cap, and unscrewing the formed screw cap from the threads of the protruded part of the first tool. The above-mentioned pre-preg means a composite material made from pre-impregnated fibers and a partially cured polymer matrix, such as epoxy or phenolic resin, or even thermoplastic mixed with liquid rubbers or resins.

Thus, there is a need for technologies to manufacture screw caps from paper- or cardboard so that there is no need for pre-preg of the kind mentioned above, or at least the need can be reduced.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a planar or non-planar geometric surface, a geometric space, or any other geometric entity that is zero, one, two, or three dimensional.

In accordance with the invention, there is provided a new system for manufacturing screw caps from cardboard or paperboard.

A system according to the invention comprises:
cutting tools configured to cut pieces of cardboard or paperboard,
folding tools configured to fold each of the pieces to form a cap blank such that a sidewall of the cap blank has two-fold cardboard or paperboard, and
shaping tools comprising support elements and a roller rotatably supported with respect to the support elements such that the support elements are configured to press a contact surface of the roller against a surface of the sidewall of the cap blank and simultaneously scroll the roller along the surface of the sidewall of the cap blank, the contact surface of the roller having a helical pattern for forming by pressing at least one thread section on the surface of the sidewall of the cap blank when the roller is scrolled along the surface of the sidewall of the cap blank.

As the at least one thread section on the surface of the sidewall of the cap blank is formed by pressing with the above-mentioned roller, there is no need for e.g. material that can shrink onto a suitable designed tool and thereby forms screw cap, but, instead, ordinary cardboard or paperboard can be used.

In this document, the words “cardboard” and “paperboard” can mean any organic fiber based flat material that is suitable for constructing a screw cap of the kind described above. Depending on requirements related to a screw cap, the material or materials of the cardboard or paperboard can be advantageously, but not necessarily, selected so the screw cap does not need to be disposed of after use, but the screw cap decomposes.

In accordance with the invention, there is also provided a new screw cap made of cardboard or paperboard. The screw cap comprises a gable wall and a sidewall connected to the gable wall. The sidewall has two-fold cardboard or paperboard so that the cardboard or paperboard is folded at an edge of the side wall, and a pressed pattern on a surface of the sidewall such that the pressed pattern constitutes at least one thread section on the surface of the sidewall.

In accordance with the invention, there is also provided a new method for manufacturing screw caps from cardboard or paperboard. The method comprises:
cutting pieces of cardboard or paperboard,
folding each of the pieces to form a cap blank such that a sidewall of the cap blank has two-fold cardboard or paperboard, and
pressing a contact surface of a roller against a surface of the sidewall of the cap blank and simultaneously scrolling the roller along the surface of the sidewall of the cap blank, the contact surface of the roller having a helical pattern that forms by pressing at least one thread section on the surface of the sidewall of the cap blank when the roller is scrolled along the surface of the sidewall of the cap blank.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF FIGURES

Exemplifying and non-limiting embodiments and their advantages are explained in greater detail below in the sense of examples and with reference to the accompanying drawings, in which:

FIGS. 1a, 1b, 1c, and 1d illustrate a system according to an exemplifying and non-limiting embodiment for manufacturing screw caps from cardboard or paperboard, and steps of a manufacturing process of a screw cap,

FIGS. 2a and 2b illustrate a screw cap according to an exemplifying and non-limiting embodiment, and

FIG. 3 shows a flowchart of a method according to an exemplifying and non-limiting embodiment for manufacturing screw caps from cardboard or paperboard.

### DESCRIPTION OF EXEMPLIFYING AND NON-LIMITING EMBODIMENTS

The specific examples provided in the description below should not be construed as limiting the scope and/or the applicability of the invention. Lists and groups of examples provided in the description are not exhaustive unless otherwise explicitly stated.

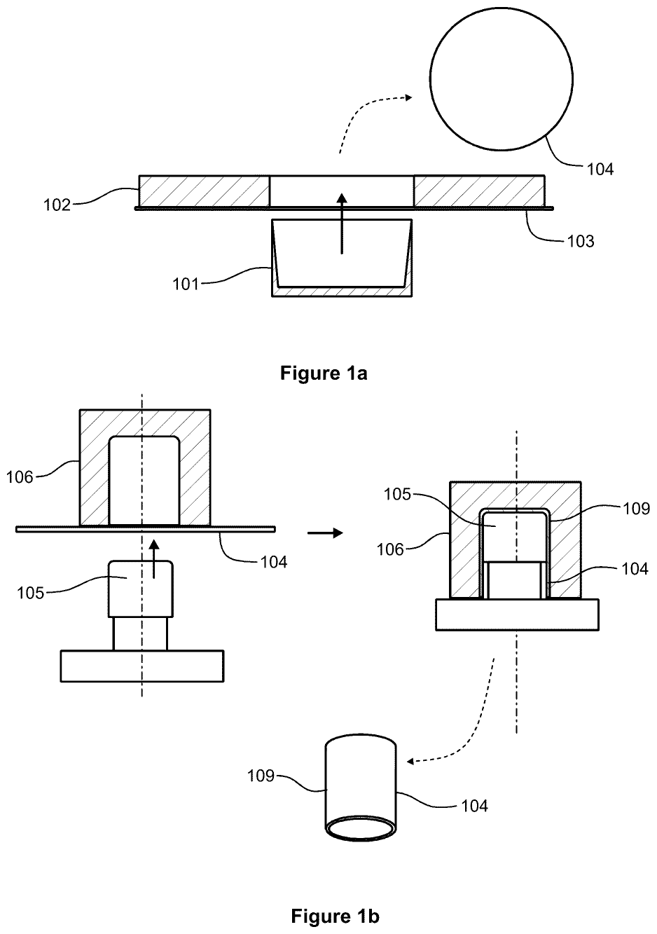

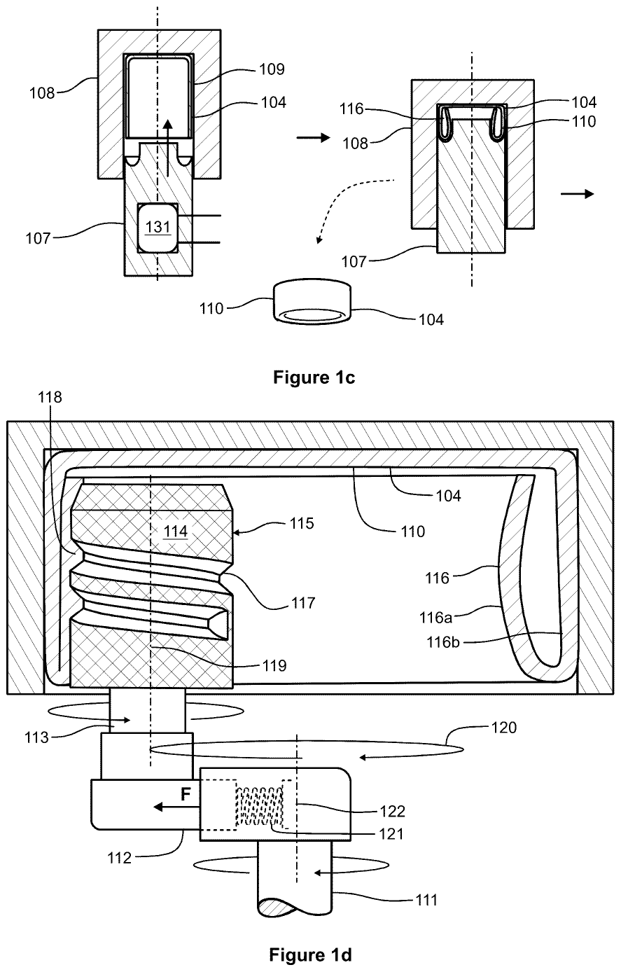

FIGS. 1a, 1b, 1c, and 1d illustrate a system according to an exemplifying and non-limiting embodiment for manufacturing screw caps from cardboard or paperboard. Furthermore, FIGS. 1a, 1b, 1c, and 1d illustrate steps of a manufacturing process of a screw cap. The system comprises cutting tools 101 and 102 configured to cut a piece 104 of cardboard or paperboard 103. The cutting tools 101 and 102 are schematically shown in FIG. 1a. Elements for operating the cutting tools 101 and 102 are not shown. In conjunction with or prior to or after the cutting, edge areas of the piece 104 can be creased to facilitate subsequent one or more folding actions. The system comprises first and second folding tools 105 and 106 configured to fold the piece 104 of cardboard or paperboard to form a cup-shaped preliminary cap blank 109. The first and second folding tools 105 and 106 are schematically shown in FIG. 1b. Elements for operating the first and second folding tools 105 and 106 are not shown. The system comprises third and fourth folding tools 107 and 108 configured to fold a sidewall of the cup-shaped preliminary cap blank 109 to form a cap blank 110 such that a sidewall 116 of the cap blank 110 has two-fold cardboard or paperboard. The third and fourth folding tools 107 and 108 are schematically shown in FIG. 1c. Elements for operating the third and fourth folding tools 107 and 108 are not shown. It is to be noted that the second and fourth folding tools 106 and 108 can be a same element that is used successively with the first and third folding tools 105 and 107 as illustrated in FIGS. 1b and 1c. It is, however, also possible that the second and fourth folding tools 106 and 108 are separate elements.

It is also possible that the folding of the sidewall of the cup-shaped preliminary cap blank 109 to be two-fold is carried out in two subsequent phases with different tools for the two subsequent phases for example so that the tool or tools for the first phase makes a gentle folding and the tool or tools for the second phase makes the folding sharper. For another example, the tool or tools for the first phase can be configured to make a pre-folding after which the sidewall of the cap blank is not yet two-fold, and the tool or tools for the second phase is/are configured to make a folding after which the sidewall of the cap blank is two-fold.

In the exemplifying system illustrated in FIGS. 1a-1d, the third folding tool 107 shown in FIG. 1b comprises a heater 131 configured to warm up the cardboard or paperboard being bent by the third and fourth folding tools 107 and 108. The temperature of the third folding tool 107 can be controlled to be e.g. within the range from 80° C. to 150° C., advantageously 100° C. The heater 131 can be, for example, an electric resistor. As mentioned above, the folding of the sidewall of the cup-shaped preliminary cap blank 109 to be two-fold can be carried out in two subsequent phases with different tools for the two subsequent phases. In this exemplifying case, the tools for both phases can be provided with a heater. Warming up the cardboard or paperboard facilitates the folding as well as subsequent phases in which the shape of the cardboard or paperboard is modified.

The system comprises shaping tools comprising support elements and a roller 114 rotatably supported with respect to the support elements. The shaping tools are schematically shown in FIG. 1d. The support elements are configured to press a contact surface 115 of the roller 114 against a surface of the sidewall 116 of the cap blank 110 and simultaneously scroll the roller 114 along the surface of the sidewall 116 of the cap blank 110. The contact surface 115 of the roller 114 can be, for example, roughened to ensure that the roller rolls along the surface of the sidewall 116 of the cap blank 110 instead of sliding. In FIG. 1d, the roughening is depicted with cross-hatching. The contact surface 115 of the roller 114 has a helical pattern 117 for forming by pressing one or more thread sections 118 on the surface of the sidewall 116 of the cap blank 110 when the roller 114 is scrolled along the surface of the sidewall 116 of the cap blank 110.

The above-mentioned folding tools are advantageously configured to fold the piece 104 to form the cap blank 110 so that a first side 116a of the sidewall 116 of the cap blank is bulging away from a second side 116b of the sidewall 116 of the cap blank to have material for forming the one or more thread sections when the roller 114 is being scrolled along the surface of the first side 116a of the sidewall 116. As shown in FIG. 1d, the folding in a part of the sidewall 116 which has not yet been pressed by the roller 114 is gentle so that there can be surplus material that can be needed when forming the one or more thread sections.

In this exemplifying case illustrated in FIGS. 1a-1d, the support elements are configured to press the contact surface 115 of the roller 114 against the inner surface of the sidewall 116 of the cap blank 110 and scroll the contact surface 115 of the roller 114 along the inner surface of the sidewall 116 of the cap blank 110. It is, however, also possible that a system according to another exemplifying and non-limiting embodiment is suitable for manufacturing a screw cap from cardboard or paperboard such that the screw cap has threads on the outer surface of the sidewall of the screw cap, i.e. the screw cap is a screw plug for closing a threaded hole. In this exemplifying case, a roller having a pattern for forming thread sections by pressing is pressed against the outer surface of the sidewall and simultaneously scrolled along the outer surface of the sidewall. Thus, the same basic principle of using a roller for forming by pressing one or more thread sections can be used when manufacturing screw caps with external threads, too.

In the exemplifying system illustrated in FIGS. 1a-1d, the support elements comprise a main shaft 111 that is coaxial with a geometric rotational symmetry line of the cap blank 110 being molded with the shaping tool. The support elements comprise an arm 112 attached to the main shaft 111 and extending sidewards from the main shaft, and a side shaft 113 parallel with the main shaft 111. The side shaft 113 is attached to the arm 112 a distance away from the main shaft 111, and the side shaft 113 is configured to rotatably support the roller 114. Elements for supporting and rotating the main shaft 111 are not shown. The main shaft 111 is advantageously rotated at least one round. In FIG. 1d, a geometric axis of rotation of the main shaft 111 is denoted with a reference 122. Thus, the roller 114 is scrolled along the surface of the sidewall 116 of the cap blank 110 so that a geometric axis of rotation 119 of the roller 114 moves at least one round along a geometric circular path 120 that is perpendicular to the geometric axis of rotation 119 of the roller. The roller 114 rotates more than one round, e.g. at least 1.1 rounds i.e. 396 degrees, around its axis of rotation 119 when being scrolled along the surface of the sidewall 116 of the cap blank 110 so that the geometric axis of rotation 119 of the roller 114 moves one round along the geometric circular path 120. The radius of the roller 114 can be selected for example so that the roller 114 rotates an integer number N rounds i.e. N×360 degrees, and no more than the N rounds, around the axis of rotation 119 of the roller 114 in a situation in which the main shaft 111 rotates 360 degrees and thereby the axis of rotation 119 of the roller 114 moves the one round, and no more than the one round, along the geometric circular path 120. In this exemplifying case, the roller 114 forms by pressing N thread sections 360/N degrees apart on the surface of the sidewall 116 of the cap blank 110. The integer number N is at least two. The integer number N can be, for example, three in which case the roller 114 forms by pressing three thread sections 120 degrees apart on the surface of the sidewall 116 of the cap blank 110.

In a system according to an exemplifying and non-limiting embodiment, the support elements comprise means for adjusting the position of the roller 114 in the direction of the axis of rotation 119 with respect to the cap blank. In this embodiment, it is possible to adjust the location of the one or more thread sections on the sidewall of the screw cap in the axial direction of the screw cap. The means for adjusting may comprise, for example, structures to adjust the position of the main shaft 111 in the axial direction of the main shaft.

A system according to an exemplifying and non-limiting embodiment comprises a heater configured to warm up the sidewall of the cap blank prior to making the one or more thread sections. A system according to another exemplifying and non-limiting embodiment comprises a cooler configured to cool the sidewall of the cap blank prior to making the one or more thread sections.

In the exemplifying system illustrated in FIGS. 1a-1d, the arm 112 comprises a force generating device 121 to press the contact surface 115 of the roller 114 against the surface of the sidewall 116 of the cap blank 110. In this exemplifying case, the force generating device 121 is a spring that is depicted with dashed lines in FIG. 1d. It is, however, also possible to use e.g. a hydraulic, pneumatic, or magnetic force generating device. Furthermore, it is also possible to use a mechanical arrangement for example such that a sidewards directed force F is obtained with an oblique surface that is pushed by a force in a direction parallel with the geometric axis of rotation 122. The force generating device can be for example such that the force F can be adjusted in a stepless way.

In the exemplifying system illustrated in FIGS. 1a-1d, the helical pattern 117 on the contact surface 115 of the roller 114 comprises a helical groove for forming each thread section to be a ridge on the surface of the sidewall 116 of the cap blank 110. It is also possible that the helical pattern on the contact surface of a roller comprises a helical ridge for forming each thread section to be a groove on the surface of the sidewall of a cap blank.

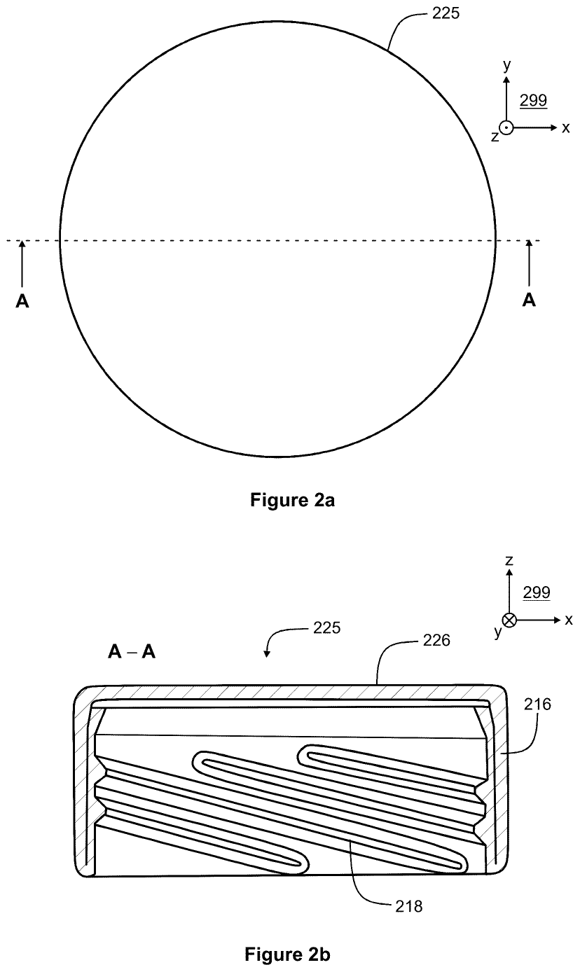

FIG. 2a shows a top view of a screw cap 225 according to an exemplifying and non-limiting embodiment, and FIG. 2b shows a section taken along a geometric line A-A shown in FIG. 2a. The geometric section plane is parallel with the geometric xz-plane of a coordinate system 299. The screw cap 225 is made of cardboard or paperboard, and the screw cap 225 comprises a gable wall 226 and a sidewall 216 connected to the gable wall. The sidewall 216 has two-fold cardboard or paperboard so that the cardboard or paperboard is folded at an edge of the side wall 216. The sidewall 216 has a pressed pattern on the inner surface of the sidewall such that the pressed pattern constitutes thread sections on the surface of the sidewall. In FIG. 2b, one of the thread sections is denoted with a reference 218.

In a screw cap according to an exemplifying and non-limiting embodiment, one or both surfaces of the cardboard or paperboard is/are coated with one or more layers for preventing penetration of oxygen through the cardboard or paperboard.

In a screw cap according to an exemplifying and non-limiting embodiment, one or both surfaces of the cardboard or paperboard is/are coated with one or more layers for improving waterproofness of the cardboard or paperboard.

In a screw cap according to an exemplifying and non-limiting embodiment, a surface of the cardboard or paperboard intended to be against a surface of a container to be closed is coated with one or more layers facilitating a tight closing.

In a screw cap according to an exemplifying and non-limiting embodiment, one or both surfaces of the cardboard or paperboard is/are coated with one or more layers for making it easier to open a container closed with the screw cap.

In a screw cap according to an exemplifying and non-limiting embodiment, a surface of the cardboard or paperboard intended to be against a surface of a container to be closed is coated with one or more layers enabling a tight closing with heat directed to the one or more layers.

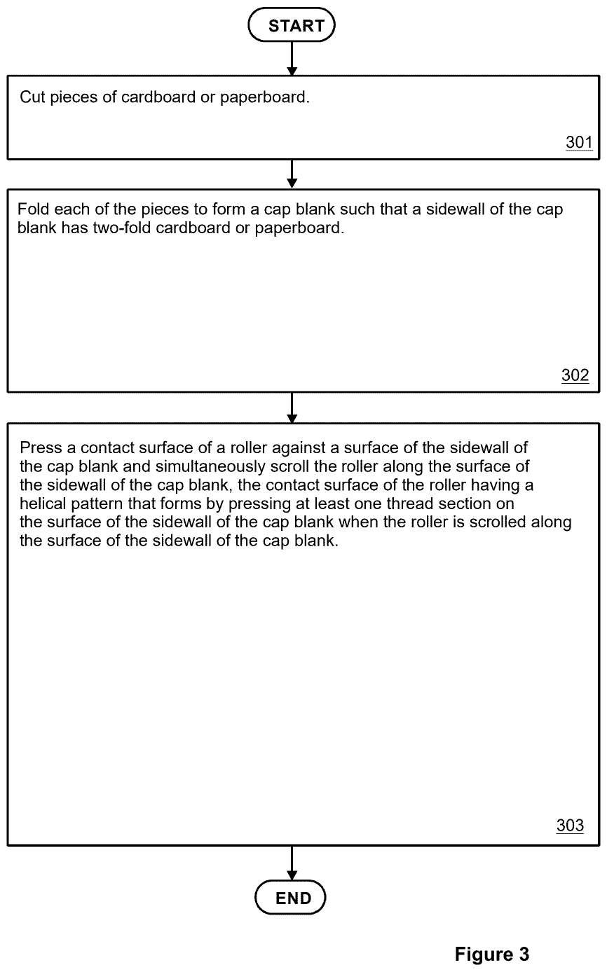

FIG. 3 shows a flowchart of a method according to an exemplifying and non-limiting embodiment for manufacturing screw caps from cardboard or paperboard. The method comprises the following actions:
action 301: cutting pieces of cardboard or paperboard,
action 302: folding each of the pieces to form a cap blank such that a sidewall of the cap blank has two-fold cardboard or paperboard, and
action 303: pressing a contact surface of a roller against a surface of the sidewall of the cap blank and simultaneously scrolling the roller along the surface of the sidewall of the cap blank, the contact surface of the roller having a helical pattern that forms by pressing at least one thread section on the surface of the sidewall of the cap blank when the roller is scrolled along the surface of the sidewall of the cap blank.

A method according to an exemplifying and non-limiting embodiment comprises, in conjunction with or prior to or after the cutting 301, creasing edge areas of each of the pieces to facilitate subsequent one or more folding actions directed to the piece.

In a method according to an exemplifying and non-limiting embodiment, the piece is folded to form the cap blank so that a first side of the sidewall of the cap blank is bulging away from a second side of the sidewall of the cap blank to have material for forming the one or more thread sections when the roller is being scrolled along the surface of the first side of the sidewall of the cap blank.

In a method according to an exemplifying and non-limiting embodiment, the sidewall of the cup-shaped preliminary cap blank is folded using third and fourth ones of the folding tools, and the third one of the folding tools comprises a heater that warms up the cardboard or paperboard being bent by the third and fourth ones of the folding tools.

In a method according to an exemplifying and non-limiting embodiment, the roller, ref. 114 in FIG. 1d, is scrolled along the surface of the sidewall, ref. 116 in FIG. 1d, of the cap blank, ref. 110 in FIG. 1d, so that an axis of rotation, ref. 119 in FIG. 1d, of the roller moves at least one round along a geometric circular path, ref. 120 in FIG. 1d, perpendicular to the axis of rotation of the roller, and the roller rotates more than one round, e.g. at least 1.1 rounds, around the axis of rotation of the roller when being scrolled along the surface of the sidewall of the cap blank so that the geometric axis of rotation of the roller moves one round along the geometric circular path.

In a method according to an exemplifying and non-limiting embodiment, the roller is scrolled along the surface of the sidewall of the cap blank so that roller rotates an integer number N of rounds, and no more than the integer number N of rounds, around the axis of rotation of the roller when the axis of rotation of the roller moves the one round, and no more than the one round, along the geometric circular path, ref. 120 in FIG. 1d. In this exemplifying embodiment, the roller forms by pressing the integer number N of thread sections 360/N degrees apart on the surface of the sidewall of the cap blank. The integer number N is at least two. The integer number N can be for example three.

In a method according to an exemplifying and non-limiting embodiment, the roller is run with support elements that comprise a main shaft being coaxial with a geometric rotational symmetry line of the cap blank, an arm attached to the main shaft and extending sidewards from the main shaft, and a side shaft parallel with the main shaft, attached to the arm a distance away from the main shaft, and configured to rotatably support the roller.

In a method according to an exemplifying and non-limiting embodiment, the arm comprises a force generating device pressing the contact surface of the roller against the surface of the sidewall of the cap blank.

In a method according to an exemplifying and non-limiting embodiment, the contact surface of the roller comprises a helical groove that forms the at least one thread section to be a ridge on the surface of the sidewall of the cap blank. In a method according to another exemplifying and non-limiting embodiment, the contact surface of the roller comprises a helical ridge that forms the at least one thread section to be a groove on the surface of the sidewall of a cap blank.

In a method according to an exemplifying and non-limiting embodiment, the contact surface of the roller is pressed against and scrolled along the inner surface of the sidewall of the cap blank. In a method according to another exemplifying and non-limiting embodiment, the contact surface of the roller is pressed against and scrolled along the outer surface of the sidewall of the cap blank.

The specific examples provided in the description given above should not be construed as limiting the applicability and/or interpretation of the invention. It is to be noted that lists and groups of examples given in this document are non-exhaustive lists and groups unless otherwise explicitly stated.

What is claimed is:

1. A system for manufacturing screw caps from cardboard or paperboard, the system comprising cutting tools configured to cut pieces of the cardboard or paperboard, the system comprising:
folding tools configured to fold each of the pieces to form a cap blank such that a sidewall of the cap blank has two-fold cardboard or paperboard, and
shaping tools comprising support elements and a roller rotatably supported with respect to the support elements such that the support elements are configured to press a contact surface of the roller against a surface of the sidewall of the cap blank and simultaneously scroll the roller along the surface of the sidewall of the cap blank, the contact surface of the roller having a helical pattern for forming by pressing at least one thread section on the surface of the sidewall of the cap blank when the roller is scrolled along the surface of the sidewall of the cap blank.

2. A system according to claim 1, wherein the support elements are configured to scroll the roller along the surface of the sidewall of the cap blank so that a geometric axis of rotation of the roller moves at least one round along a geometric circular path perpendicular to the geometric axis of rotation of the roller, and the roller rotates more than one round around the axis of rotation of the roller when being scrolled along the surface of the sidewall of the cap blank so that the geometric axis of rotation of the roller moves one round along the geometric circular path.

3. A system according to claim 2, wherein the support elements are configured to scroll the roller along the surface of the sidewall of the cap blank so that roller rotates an integer number of rounds, and no more than the integer number of rounds, around the axis of rotation of the roller in a situation in which the axis of rotation of the roller moves the one round, and no more than the one round, along the geometric circular path, the roller being configured to form by pressing the integer number of thread sections 360/the integer number degrees apart on the surface of the sidewall of the cap blank, and the integer number being at least two.

4. A system according to claim 1, wherein the support elements comprise a main shaft being coaxial with a geometric rotational symmetry line of the cap blank being molded with the shaping tools, an arm attached to the main shaft and extending sidewards from the main shaft, and a side shaft parallel with the main shaft, attached to the arm a distance away from the main shaft, and configured to rotatably support the roller.

5. A system according to claim 4, wherein the arm comprises a force generating device to press the contact surface of the roller against the surface of the sidewall of the cap blank.

6. A system according to claim 1, wherein the helical pattern comprises a helical groove on the contact surface of the roller for forming each of the at least one thread section to be a ridge on the surface of the sidewall of the cap blank.

7. A system according to claim 1, wherein the support elements are configured to press the contact surface of the roller against an inner surface of the sidewall of the cap blank and scroll the contact surface of the roller along the inner surface of the sidewall of the cap blank.

8. A system according to claim 1, wherein the folding tools are configured to fold the piece to form the cap blank so that a first side of the sidewall of the cap blank is bulging away from a second side of the sidewall of the cap blank to have material for forming the one or more thread sections when the roller is being scrolled along a surface of the first side of the sidewall of the cap blank.

9. A system according to claim 1, wherein first and second ones of the folding tools are configured to fold the piece of the cardboard or paperboard to a cup-shaped preliminary cap blank, third and fourth ones of the folding tools are configured to fold a sidewall of the cup-shaped preliminary cap blank, and the third one of the folding tools comprises a heater configured to warm up the cardboard or paperboard to be bent by the third and fourth ones of the folding tools.

10. A screw cap made of cardboard or paperboard, the screw cap comprising a gable wall and a sidewall connected to the gable wall, wherein the sidewall has two-fold cardboard or paperboard so that the cardboard or paperboard is folded at an edge of the side wall, and a pressed pattern on a surface of the sidewall such that the pressed pattern constitutes at least one thread section on the surface of the sidewall.

11. A method for manufacturing screw caps from cardboard or paperboard, the method comprising:
cutting pieces of the cardboard or paperboard,
folding each of the pieces to form a cap blank such that a sidewall of the cap blank has two-fold cardboard or paperboard, and
pressing a contact surface of a roller against a surface of the sidewall of the cap blank and simultaneously scrolling (303) the roller along the surface of the sidewall of the cap blank, the contact surface of the roller having a helical pattern that forms by pressing at least one thread section on the surface of the sidewall of the cap blank when the roller is scrolled along the surface of the sidewall of the cap blank.

12. A method according to claim 11, wherein the roller is scrolled along the surface of the sidewall of the cap blank so that an axis of rotation of the roller moves at least one round along a geometric circular path perpendicular to the axis of rotation of the roller, and the roller rotates more than one round around the axis of rotation of the roller when being scrolled along the surface of the sidewall of the cap blank so that the geometric axis of rotation of the roller moves one round along the geometric circular path.

13. A method according to claim 11, wherein the roller is scrolled along the surface of the sidewall of the cap blank so that roller rotates an integer number of rounds, and no more than the integer number of rounds, around the axis of rotation of the roller in a situation in which the axis of rotation of the roller moves the one round, and no more than the one round, along the geometric circular path, the roller forming by pressing the integer number of thread sections 360/the integer number degrees apart on the surface of the sidewall of the cap blank, and the integer number being at least two.

14. A method according to claim 11, wherein the roller is run with support elements that comprise a main shaft being coaxial with a geometric rotational symmetry line of the cap blank, an arm attached to the main shaft and extending sidewards from the main shaft, and a side shaft parallel with the main shaft, attached to the arm a distance away from the main shaft, and configured to rotatably support the roller.

15. A method according to claim 14, wherein the arm comprises a force generating device pressing the contact surface of the roller against the surface of the sidewall of the cap blank.

16. A system according to claim 2, wherein the support elements comprise a main shaft being coaxial with a geometric rotational symmetry line of the cap blank being molded with the shaping tools, an arm attached to the main shaft and extending sidewards from the main shaft, and a side shaft parallel with the main shaft, attached to the arm a distance away from the main shaft, and configured to rotatably support the roller.

17. A system according to claim 3, wherein the support elements comprise a main shaft being coaxial with a geometric rotational symmetry line of the cap blank being molded with the shaping tools, an arm attached to the main shaft and extending sidewards from the main shaft, and a side shaft parallel with the main shaft, attached to the arm a distance away from the main shaft, and configured to rotatably support the roller.

18. A system according to claim 2, wherein the helical pattern comprises a helical groove on the contact surface of the roller for forming each of the at least one thread section to be a ridge on the surface of the sidewall of the cap blank.

19. A system according to claim 2, wherein the helical pattern comprises a helical groove on the contact surface of the roller for forming each of the at least one thread section to be a ridge on the surface of the sidewall of the cap blank.

20. A system according to claim 3, wherein the helical pattern comprises a helical groove on the contact surface of the roller for forming each of the at least one thread section to be a ridge on the surface of the sidewall of the cap blank.
